(19) United States
(12) Patent Application Publication
(10) Pub. No.: US 2026/0004377 A1
(43) Pub. Date: Jan. 1, 2026

(54) WORKFLOW CREATION

(71) Applicant: Beijing Zitiao Network Technology Co., Ltd., Beijing (CN)

(72) Inventors: Yiqi Xiao, Beijing (CN); Lan Ma, Beijing (CN); Jinning Mai, Beijing (CN)

(21) Appl. No.: 18/891,665

(22) Filed: Sep. 20, 2024

(30) Foreign Application Priority Data
Jun. 30, 2024 (CN) 202410870014.2

(51) Int. Cl. G06T 1/00; G06F 3/0484

(52) U.S. Cl. CPC G06T 1/00; G06F 3/0484

(57) ABSTRACT

The embodiments of the invention relate to a workflow creation method, apparatus, device, and a storage medium. One method provided herein includes: in response to receiving an editing operation, adding a first node associated with a canvas configuration to a node connected graph; determining canvas configuration information based on a set of configuration controls associated with the first node, the canvas configuration information indicating at least a layout of a set of elements in the canvas, the set of elements including a first element configured by referencing a second node associated with the first node; and creating a target workflow based on the node connected graph, the first node in the target workflow being configured to output an image processing result based on the canvas configuration information. In this way, the embodiments of the present disclosure can improve the efficiency of image processing using a workflow.

### CROSS-REFERENCE

The present application claims priority to Chinese Patent Application No. 202410870014.2, filed on Jun. 30, 2024, and entitled “WORKFLOW CREATION METHOD, APPARATUS, DEVICE AND STORAGE MEDIUM”, the entirety of which is incorporated herein by reference.

### FIELD

Example embodiments of the present disclosure generally relate to the field of computers, and more particularly, to workflow creation.

### BACKGROUND

With the development of computer technologies, people can create various types of applications on different platforms. In the process of developing applications, it is an important task to create and manage workflows. For example, a user may define a workflow for image processing (also referred to as an image flow) to implement an automated image processing flow.

### SUMMARY

In a first aspect of the present disclosure, a method for workflow creation is provided. The method includes: in response to receiving an editing operation, adding a first node associated with a canvas configuration to a node connected graph; determining canvas configuration information based on a set of configuration controls associated with the first node, the canvas configuration information indicating at least a layout of a set of elements in a canvas, the set of elements including a first element configured by referencing a second node of the node connected graph that is associated with the first node; and creating a target workflow based on the node connected graph, the first node in the target workflow being configured to output an image processing result based on the canvas configuration information.

In a second aspect of the present disclosure, an apparatus for workflow creation is provided. The apparatus includes: an adding module configured to add a first node associated with a canvas configuration to a node connected graph in response receiving an editing operation; a determination module configured to determine canvas configuration information based on a set of configuration controls associated with the first node, the canvas configuration information indicating at least a layout of a set of elements in the canvas, the set of elements including a first element configured by referencing a second node associated with the first node; and a creation module configured to create a target workflow based on the node connected graph, the first node in the target workflow being configured to output an image processing result based on the canvas configuration information.

In a third aspect of the present disclosure, an electronic device is provided. The apparatus includes at least one processing unit; and at least one memory coupled to the at least one processing unit and storing instructions executable by the at least one processing unit. The instructions, when executed by the at least one processing unit, cause the device to perform operations that implement the method of the first aspect.

In a fourth aspect of the present disclosure, a computer-readable storage medium is provided. The computer-readable storage medium stores a computer program, and the computer program is executable by the processor to perform operations that implement the method of the first aspect.

It would be appreciated that the content described in this section is not intended to limit key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description with reference to the accompanying drawings. In the drawings, the same or similar reference numbers refer to the same or similar elements, wherein:

FIG. 1 illustrates a schematic diagram of an example environment.

FIG. 2 illustrates a flowchart of an example process of workflow creation.

FIGS. 3A to 3C illustrate example interfaces.

FIG. 4 illustrates a schematic structural block diagram of an example apparatus for workflow creation.

FIG. 5 illustrates a block diagram of an example electronic device in which various embodiments of the present disclosure may be implemented.

### DETAILED DESCRIPTION

The embodiments of the present disclosure will be described in more details below with reference to the accompanying drawings. Although certain embodiments of the present disclosure are shown in the drawings, it would be appreciated that the present disclosure can be implemented in various forms and should not be interpreted as limited to the embodiments described herein. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

It should be noted that the headline of any section/subsection provided in the specification is not limiting. Various embodiments are described throughout the specification and any type of embodiments may be included in any section/subsection. Furthermore, the embodiments described in any section/subsection may be combined in any manner with any other embodiment described in the same section/subsection and/or different sections/subsections.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below.

The embodiments of the present disclosure may relate to user data, acquisition and/or use of data, and the like. These aspects shall comply with the requirements of corresponding laws, regulations and relevant provisions. In the embodiments of the present disclosure, the collection, acquisition, processing, manufacturing, forwarding, use of all data and the like are carried out with the user's knowledge and consent. Accordingly, in the implementation of the embodiments of the present disclosure, users should be informed of the type, the scope of use, the use scenario, etc., of the involved data or information in an appropriate manner and provide authorization in accordance with relevant laws and regulations. The specific ways of being informed and providing authorization may vary according to actual circumstances and application scenarios, and the scope of this disclosure is not limited in this regard.

In the solutions and embodiments in this disclosure, if personal information processing is involved, it will be carried out based on legitimate grounds (such as obtaining consent from the data subject, or as required to fulfill a contract”, etc.) and will be processed only within the specified or agreed scope. If users decline the processing of personal information beyond what is essential for basic functionalities, their utilization of these basic features remains uninterrupted.

Traditionally, users can quickly create workflows by, for example, configuring various processing nodes in a workflow. For example, a user may create a workflow for image processing to implement an automated image processing flow. However, in the conventional procedure for image workflow creation, it is difficult for the users to customize an image layout effectively.

The embodiments of the present disclosure provide a solution of workflow creation. According to the solution, in response to a received editing operation, a first node associated with a canvas configuration is added to a node connected graph. Canvas configuration information is determined via a set of configuration controls associated with the first node, and the canvas configuration information indicates at least a layout of a set of elements in the canvas, the set of elements including a first element configured by referencing a second node associated with the first node. A target workflow is then created based on the node connected graph, the first node in the target workflow being configured to output an image processing result based on the canvas configuration information.

In this way, in the embodiments of the present disclosure, a canvas node can be added in the workflow for managing the layout of elements in the canvas according to a desired style. As such, the editing efficiency of the target workflow and image processing efficiency of the target workflow can be improved.

Various example implementations of this solution will be described in detail below with reference to the accompanying drawings.

### Example Environment

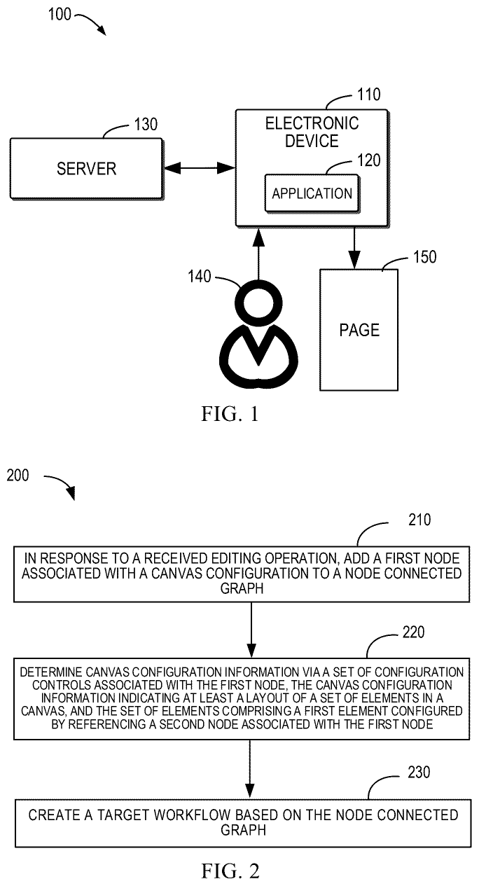

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to, development applications or other suitable applications that support workflow creation. A user 140 may interact with the application 120 via the electronic device 110 and/or its attached device.

In the environment 100 of FIG. 1, if the application 120 is active, the electronic device 110 may present, via the application 120, a page 150 for supporting workflow creation.

In some embodiments, the electronic device 110 communicates with a server 130 to enable provisioning of services to the application 120. The electronic device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for the application 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In the embodiments of the present disclosure, the server 130 and the electronic device 110 may implement signaling interaction through a communication connection between the server 130 and the electronic device 110.

It would be appreciated that the structures and functions of the various elements in the environment 100 are described for exemplary purposes only and do not imply any limitation to the scope of the present disclosure.

Some example embodiments of the present disclosure will be described below with continued reference to the accompanying drawings.

### Example Processes

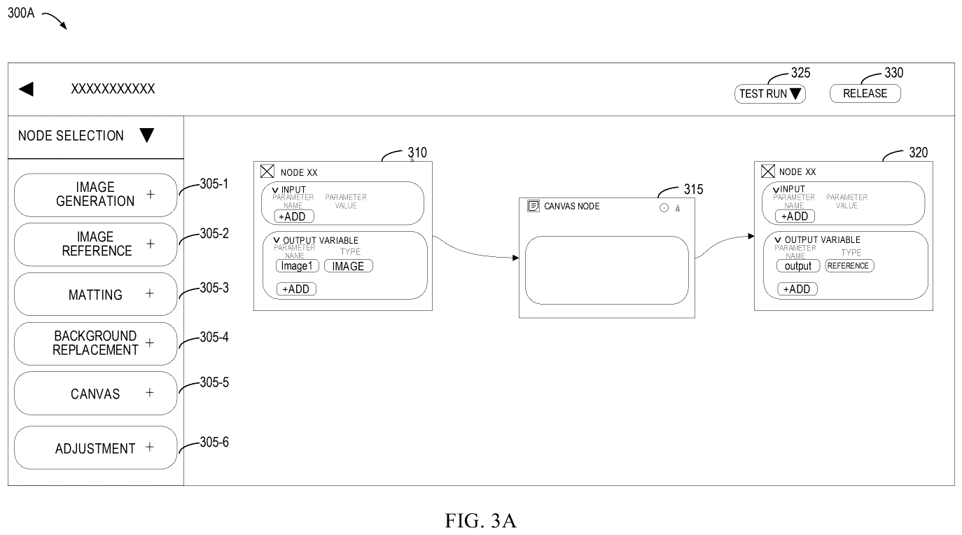

FIG. 2 illustrates a flowchart of a process 200 of workflow creation according to some embodiments of the present disclosure. In the context of the present disclosure, the “workflow creation” may include various forms of workflow creation. For example, the example process 200 may be used to create a new workflow, or an editing interface as described below may be used to open and edit an existing workflow. The process 200 may be implemented at the electronic device 110. The process 200 is described below with reference to FIG. 1.

As shown in FIG. 2, at block 210, in response to a received editing operation, the electronic device 110 adds a first node associated with a canvas configuration to a node connected graph.

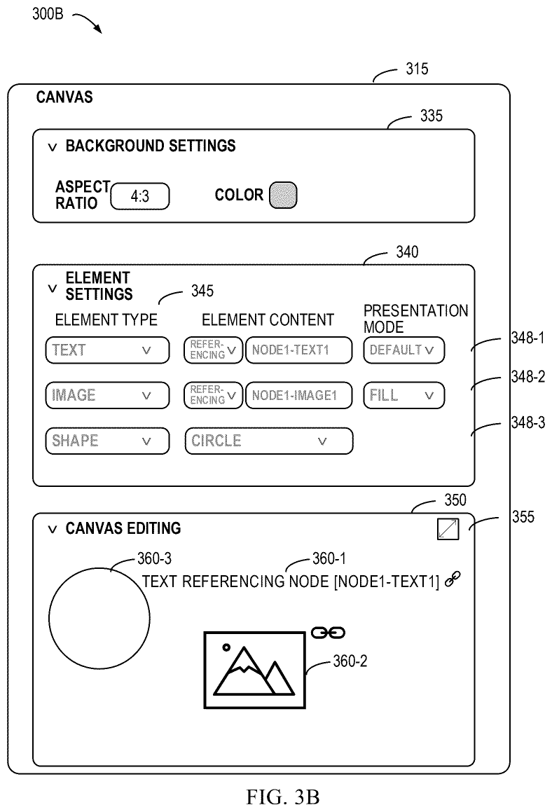

The process 200 will be described below with reference to FIG. 3A. FIG. 3A illustrates an example editing interface 300A in accordance with some embodiments of the present disclosure.

As shown in FIG. 3A, the interface 300A may be a node editing interface for creating a workflow (also referred to as an image flow) for image processing. As shown, the electronic device 110 may present, in the interface 300A, a plurality of interface elements corresponding to a plurality of node types, for example, interface elements 305-1 to 305-6. As an example, the interface element 305-1 may be used to add an image generation node, the interface element 305-2 may be used to add an image reference node, the interface element 305-3 may be used to add a matting node, the interface element 305-4 may be used to add a background replacement node, the interface element 305-5 may be used to add a canvas node, and the interface element 305-6 may be used to add an adjustment node. The above nodes may also be collectively referred to as image processing nodes.

In some embodiments of the present disclosure the addition of any other suitable type of nodes in addition to the specific nodes above is supported. For example, the electronic device 110 may enable the user to add an image flow that has been created to the node connected graph as a single processing node.

As an example, the electronic device 110 may receive a user selection of the interface element 305-5 to add a first node 315 to the node connected graph. The first node 315, also referred to as a canvas node, is used for configuring canvas information in an image processing process.

At block 220, the electronic device 110 determines, via a set of configuration controls associated with the first node, canvas configuration information indicating at least a layout of a set of elements in the canvas, the set of elements including a first element configured by referencing a second node associated with the first node.

As shown in FIG. 3A, in a node connected graph, the first node 315 may have one or more preceding nodes. The preceding node(s) may include a node directly connected to the first node 315, e.g., a second node 310. Alternatively, the preceding node(s) may include a node which is not directly connected to the first node 315 but has a connection path.

Additionally, in the node connected graph, the first node 315 may further have one or more subsequent nodes, for example, a third node 320. As an example, an image processing result of the first node 315 may be used as an input of the third node 320. It would be appreciated that the first node 315 may also be, for example, the last node in the workflow.

The specific configuration process of the canvas node will be described in detail below with reference to FIGS. 3B and 3C.

FIG. 3B shows a configuration window 300B of the first node 315. As shown in FIG. 3B, the configuration window 300B may include a set of configuration controls, such as a configuration control 335, a configuration control 340, and a configuration control 355.

In some embodiments, as shown in FIG. 3B, the configuration control 335 may be configured to set size information of the canvas, for example, a canvas aspect ratio and a size. Alternatively, the configuration control 335 may be also configured to set a background style of the canvas, for example, a background color, a background pattern, or the like.

In some embodiments, as shown in FIG. 3B, the configuration control 340 may be configured to obtain element configuration information 345 to configure one or more elements (also referred to as canvas elements) to be added in the canvas. Taking FIG. 3B as an example, the element configuration information 345 may indicate three canvas elements 348-1, 348-2, and 348-3 (individually or collectively referred to as canvas elements 348).

In some embodiments, as shown in FIG. 3B, element configuration information 345 may indicate a type of canvas element 348. For example, the canvas element 348-1 is a text element, the canvas element 348-2 is an image element, and the canvas element 348-3 is a shape element.

Additionally, the element configuration information 345 may also indicate the content of each canvas element 348. In some embodiments, the configuration control 340 may support the users to configure the canvas element 348-1 or canvas element 348-2 by referencing a node associated with first node 315. In some embodiments, the node associated with the first node 315 may include a preceding node, e.g., the second node 310, of the first node 315 in the node connected graph. Such a preceding node may not be directly connected to the first node 315.

As shown in FIG. 3B, the electronic device 110 may use the configuration control 340 to configure the content of the canvas element 348-1 to reference the data “TEXT1” in “node 1”, and to configure the content of the canvas element 348-2 to reference the data “IMAGE1” in the “node 1”.

Further, for the canvas element 348-3, the electronic device 110 can support the user configuration of a specific type of shape, for example, a circle.

In some embodiments, the element configuration information 345 may also indicate a present mode of the canvas element 348-1 and the canvas element 348-2. For example, taking the canvas element 348-2 as an example, the element configuration information 345 may indicate using the image “IMAGE1” in the “node 1” to fill in a corresponding area in the canvas.

In some embodiments, as shown in FIG. 3B, the configuration window 300B further includes a canvas editing control 350. Further, in response to the canvas element 348 being configured in the configuration control 340, the electronic device 110 may add an indication element corresponding to the configured canvas element 348 in the canvas editing control 350.

For example, an indication element 360-1 may correspond to the configured canvas element 348-1, an indication element 360-2 may correspond to the canvas element 348-2, and an indication element 360-3 may correspond to the canvas element 348-3.

In some embodiments, for a canvas element (e.g., the canvas element 348-1 or 348-2) configured by referencing a further node, its corresponding indication element (e.g., the indication element 360-1 or 360-2) may include an identifier to indicate that the content source of the indication element references the further node.

Further, based on layout information of each indication element 360 in the canvas editing control 350, the electronic device 110 may determine a layout of the corresponding canvas elements 348 in the canvas of the first node 315.

In some embodiments, such layout information may include, but is not limited to, information indicating a position, a size, an orientation of the indication element 360 in the canvas editing control 350.

Additionally, the electronic device 110 may also receive an editing operation for the indication element 360 to adjust the layout information of the indication element 360 in the canvas editing control 350. For example, the user may drag the indication element 360 to adjust its position and may use an appropriate editing operation to adjust the size, orientation, etc. of the indication element 360.

In some embodiments, the electronic device 110 may also determine style information of the indication element 360 via the canvas editing control 350. The style information may include, for example, a font style of the text, a style of the image, a line style of the graphic, and the like. Further, the electronic device 110 may determine, based on the configured style information, a presentation style of the corresponding canvas element 348 in the canvas.

In some embodiments, as shown in FIG. 3B, the electronic device 110 may further provide a control 355 to support providing a canvas editing area with a larger size. As shown in FIG. 3C, the electronic device 110 may present a window 300C as shown in FIG. 3C based on a selection of the control 355.

As shown in FIG. 3C, the window 300C may, for example, provide a canvas editing area 375 of a larger size and may also provide one or more editing controls 370. The editing controls 370 may include, for example, a control configured for adding one or more input elements to the canvas editing area 375.

In some embodiments, the electronic device 110 may receive an element adding operation via the canvas editing control. For example, the electronic device 110 may input a text element 380 in the canvas editing area 375 based on a user selection of a text editing control.

Accordingly, the text element 380 is added to an image output result of the first node 315 according to its layout and style in the canvas editing area 375 during the processing of the first node 315.

As an example, the users may, for example, add appropriate elements such as a text element, an image element, a shape element, a hand-drawn element, etc., by using the editing control 370, and may edit the layout and/or style of these elements in the canvas in a similar process.

Further, the electronic device 110 may determine layout information and/or style information of the element in the canvas of the first node 315 based on the canvas editing control 350. This enables the first node 315 to output a corresponding image processing result based on such configuration information.

Taking FIG. 3C as an example, during the processing of the first node 315, the first node 315 may obtain the data “TEXT1” and “IMAGE1” defined in the second node 310 and use the data to fill in the indication elements 360-1 and 360-2 to determine the elements to be presented in the canvas.

Further, the first node 315 may generate the image processing result of the first node 315 by adding the one or more configured elements in the configured canvas.

At block 230, the electronic device 110 creates a target workflow based on the node connected graph.

With continued reference to FIG. 3A, in some embodiments, after the editing of the node connected graph is complete, the electronic device 110 may, for example, trigger a corresponding debugging process based on a control 325.

In some embodiments, to improve the debugging efficiency, the electronic device 110 may further present a management interface (for example, a debugging interface) of the target workflow in an execution process (for example, a debugging process) of the target workflow.

Further, the electronic device 110 may display node windows corresponding to a plurality of processing nodes in the target workflow. Further, the electronic device 110 may display, in a node window corresponding to an image processing node, an image processing result output by the image processing node. For example, the electronic device 110 may display, in the respective node window, a preview image generated by each image processing node, so as to facilitate the users to debug and manage the execution of the workflow.

Additionally, the electronic device 110 may also create and release a corresponding target workflow based on a trigger for a control 330. As an example, the electronic device 110 may create a corresponding target workflow based on the configuration information of each node in the node connected graph and the connection between nodes. Such a target workflow may be released or shared to other users, for example.

In some embodiments, the target workflow may be released independently, or may trigger creation and/or publication of an application based on the target workflow, e.g., a bot or an agent.

Based on the above process, the embodiments of the present disclosure can support adding a canvas node in the workflow to manage the layout of elements in the canvas according to the desired style. As such, the editing efficiency of the target workflow and the image processing efficiency of the target workflow can be improved.

### Example Apparatus and Apparatus

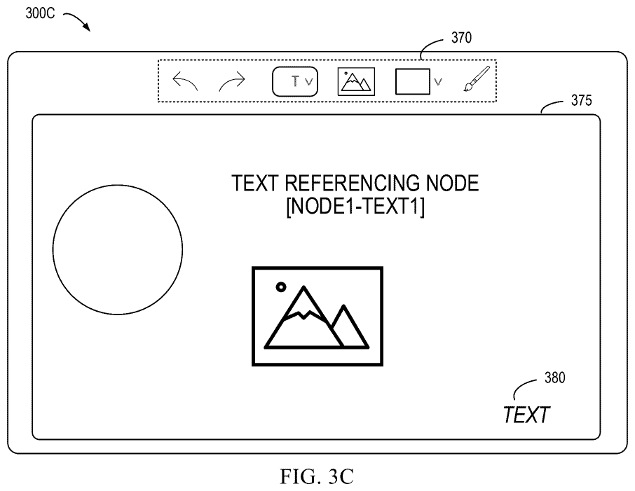

Embodiments of the present disclosure also provide a corresponding apparatus for implementing the above method or process. FIG. 4 shows a schematic structural block diagram of an example apparatus 400 for workflow creation according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes: an adding module 410 configured to in response to receiving an editing operation, add a first node associated with a canvas configuration to a node connected graph; a determining module 420 configured to determine canvas configuration information based on a set of configuration controls associated with the first node, the canvas configuration information indicating at least a layout of a set of elements in a canvas, and the set of elements comprising a first element configured by referencing a second node of the node connected graph that is associated with the first node; and a creation module 430 configured to create a target workflow based on the node connected graph, the first node in the target workflow being configured to output an image processing result based on the canvas configuration information.

In some embodiments, the canvas configuration information further indicates at least one of the following: size information of the canvas, or a background style of the canvas.

In some embodiments, the set of configuration controls comprise a canvas editing control, and the determining module 420 is further configured to: in response to the first element being configured in the first node, add a first indication element corresponding to the first element in the canvas editing control; and determine the layout of the first element in the canvas based on layout information of the first indication element in the canvas editing control.

In some embodiments, the apparatus 400 further includes an adjustment module configured to, in response to receiving an editing operation on the first indication element, adjust the layout information of the first indication element in the canvas editing control.

In some embodiments, the apparatus 400 further includes a style determining module configured to determine style information of the first indication element via the canvas editing control; and determine a presentation style of the first element in the canvas based on the style information.

In some embodiments, the determining module 420 is further configured to: receiving an element adding operation via the canvas editing control; and adding a third element to the canvas editing control based on the element adding operation, such that the third element is comprised in the image processing result output by the first node, the third element comprising at least one of a text element, a graphic element, or an image element.

In some embodiments, the set of configuration controls comprise an element configuration control, and the determining module 420 is further configured to: obtain element configuration information via the element configuration control, the element configuration information indicating the set of elements associated with the first node.

In some embodiments, the element configuration information indicates at least one of the following: identification information of an element, source information of an element, or a presentation mode of an element.

In some embodiments, the set of elements further comprise a second element input via the canvas editing control.

In some embodiments, the target workflow comprises at least one image processing node, the at least one image processing node comprises the first node, and the apparatus 400 further includes a preview module configured to: in response to the target workflow being executed, displaying a target interface of the target workflow, the target node comprising at least one node window corresponding to the at least one image processing node; and displaying an image processing result output by the at least one image processing node in the at least one node window respectively.

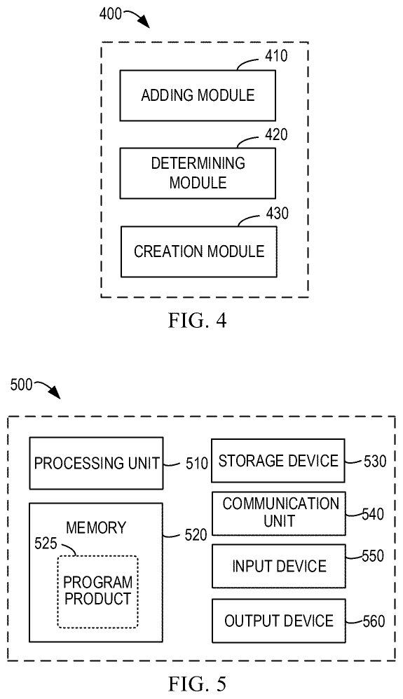

FIG. 5 illustrates a block diagram of an electronic device 500 in which one or more embodiments of the present disclosure may be implemented. It would be appreciated that the electronic device 500 illustrated in FIG. 5 is merely exemplary and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to a program stored in the memory 520. In a multiprocessor system, multiple processing units execute computer-executable instructions in parallel to improve the parallel processing capabilities of electronic device 500.

Electronic device 500 typically includes a variety of computer storage media. Such media may be any available media that is accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium which can be used to store information and/or data and can be accessed within the electronic device 500.

The electronic device 500 may further include additional removable/non-removable, volatile/non-volatile storage media. Although not shown in FIG. 5, a disk driver for reading from or writing to a removable, non-volatile magnetic disk (e.g., a “floppy disk”) and an optical disk drive for reading from or writing to a removable, non-volatile optical disk may be provided. In these cases, each driver may be connected to a bus (not shown) by one or more data media interfaces. The memory 520 may include a computer program product 525 having one or more program modules configured to execute various methods or actions of the various embodiments of the present disclosure.

The communication unit 540 is configured to communicate with other electronic devices through a communication medium. Additionally, the functionality of components of the electronic device 500 may be implemented by a single computing cluster or multiple computing machines capable of communicating through a communication connection. Thus, the electronic device 500 may operate in a networking environment using a logical connection with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed. The external device, such as a storage device, a display device, etc., communicates with one or more devices that enable users to interact with the electronic device 500, or communicates with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided. The computer program product is tangibly stored on a non-transitory computer-readable medium and includes computer-executable instructions. The computer-executable instructions are executed by a processor to implement the method described above.

Various aspects of the present disclosure are described herein with reference to flowcharts and/or block diagrams of methods, apparatuses, devices, and computer program products implemented in accordance with the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other devices, such that a series of operational steps can be performed on a computer, other programmable data processing apparatus, or other devices to produce a computer-implemented process such that the instructions executed on a computer, other programmable data processing apparatus, or other apparatus implement the functions/acts specified in the flowchart and/or block diagram block or blocks.

The flowchart and block diagrams in the drawings show the possible architecture, functions and operations of the system, the method, and the computer program product implemented according to various implementations of the present disclosure. In this regard, each block in the flowchart or block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Various implementations of the present disclosure have been described above. The above description is exemplary, not exhaustive, and does not limit to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

1. A method for workflow creation, comprising:
in response to receiving an editing operation, adding a first node associated with a canvas configuration to a node connected graph;
determining canvas configuration information based on a set of configuration controls associated with the first node, the canvas configuration information indicating at least a layout of a set of elements in a canvas, and the set of elements comprising a first element configured by referencing a second node of the node connected graph that is associated with the first node; and
creating a target workflow based on the node connected graph, the first node in the target workflow being configured to output an image processing result based on the canvas configuration information.

2. The method of claim 1, wherein the canvas configuration information further indicates at least one of the following:
size information of the canvas, or
a background style of the canvas.

3. The method of claim 1, wherein the set of configuration controls comprise a canvas editing control, and determining the canvas configuration information based on the set of configuration controls associated with the first node comprises:
in response to the first element being configured in the first node, adding a first indication element corresponding to the first element in the canvas editing control; and
determining the layout of the first element in the canvas based on layout information of the first indication element in the canvas editing control.

4. The method of claim 3, further comprising:
in response to receiving an editing operation on the first indication element, adjusting the layout information of the first indication element in the canvas editing control.

5. The method of claim 3, further comprising:
determining style information of the first indication element via the canvas editing control; and
determining a presentation style of the first element in the canvas based on the style information.

6. The method of claim 3, wherein determining the canvas configuration information based on the set of configuration controls associated with the first node comprises:
receiving an element adding operation via the canvas editing control; and
adding a third element to the canvas editing control based on the element adding operation, such that the third element is comprised in the image processing result output by the first node, the third element comprising at least one of a text element, a graphic element, or an image element.

7. The method of claim 1, wherein the set of configuration controls comprise an element configuration control, and determining the canvas configuration information based on the set of configuration controls associated with the first node comprises:
obtaining element configuration information via the element configuration control, the element configuration information indicating the set of elements associated with the first node.

8. The method of claim 7, wherein the element configuration information indicates at least one of the following:
identification information of an element,
source information of an element, or
a presentation mode of an element.

9. The method of claim 3, wherein the set of elements further comprise a second element input via the canvas editing control.

10. The method of claim 1, wherein the target workflow comprises at least one image processing node, the at least one image processing node comprises the first node, and the method further comprises:
in response to the target workflow being executed, displaying a target interface of the target workflow, the target node comprising at least one node window corresponding to the at least one image processing node; and
displaying an image processing result output by the at least one image processing node in the at least one node window respectively.

11. An electronic device comprising:
at least one processing unit; and
at least one memory coupled to the at least one processing unit and storing instructions for execution by the at least one processing unit, the instructions, when executed by the at least one processing unit, causing the electronic device to perform operations comprising:
in response to receiving an editing operation, adding a first node associated with a canvas configuration to a node connected graph;
determining canvas configuration information based on a set of configuration controls associated with the first node, the canvas configuration information indicating at least a layout of a set of elements in a canvas, and the set of elements comprising a first element configured by referencing a second node of the noted connected graph that is associated with the first node; and
creating a target workflow based on the node connected graph, the first node in the target workflow being configured to output an image processing result based on the canvas configuration information.

12. The electronic device of claim 11, wherein the canvas configuration information further indicates at least one of the following:
size information of the canvas, or
a background style of the canvas.

13. The electronic device of claim 11, wherein the set of configuration controls comprise a canvas editing control, and determining the canvas configuration information based on the set of configuration controls associated with the first node comprises:
in response to the first element being configured in the first node, adding a first indication element corresponding to the first element in the canvas editing control; and
determining the layout of the first element in the canvas based on layout information of the first indication element in the canvas editing control.

14. The electronic device of claim 13, wherein the operations further comprise:
in response to receiving an editing operation on the first indication element, adjusting the layout information of the first indication element in the canvas editing control.

15. The electronic device of claim 13, wherein the operations further comprise:
determining style information of the first indication element via the canvas editing control; and
determining a presentation style of the first element in the canvas based on the style information.

16. The electronic device of claim 13, wherein determining the canvas configuration information based on the set of configuration controls associated with the first node comprises:
receiving an element adding operation via the canvas editing control; and
adding a third element to the canvas editing control based on the element adding operation, such that the third element is comprised in the image processing result output by the first node, the third element comprising at least one of a text element, a graphic element, or an image element.

17. The electronic device of claim 11, wherein the set of configuration controls comprise an element configuration control, and determining the canvas configuration information based on the set of configuration controls associated with the first node comprises:
obtaining element configuration information via the element configuration control, the element configuration information indicating the set of elements associated with the first node.

18. The electronic device of claim 17, wherein the element configuration information indicates at least one of the following:
identification information of an element,
source information of an element, or
a presentation mode of an element.

19. The electronic device of claim 13, wherein the set of elements further comprise a second element input via the canvas editing control.

20. A non-transitory computer-readable storage medium having a computer program stored thereon, the computer program being executable by a processor to implement a method comprising:
in response to receiving an editing operation, adding a first node associated with a canvas configuration to a node connected graph;
determining canvas configuration information based on a set of configuration controls associated with the first node, the canvas configuration information indicating at least a layout of a set of elements in a canvas, and the set of elements comprising a first element configured by referencing a second node of the node connected graph that is associated with the first node; and
creating a target workflow based on the node connected graph, the first node in the target workflow being configured to output an image processing result based on the canvas configuration information.
